(19) United States
(12) Patent Application Publication
(10) Pub. No.: US 2007/0050059 A1
(43) Pub. Date: Mar. 1, 2007

(54) Digital audio signal player

(76) Inventor: Shen-Chi Liu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/209,633

(22) Filed: Aug. 24, 2005

(51) Int. Cl. G06F 17/00

(52) U.S. Cl. 700/94

(57) ABSTRACT

An audio signal player includes a turntable unit, a conductive touch-control plate on top of the turntable unit, a round disk, a conductive central shaft joined to the touch-control plate and the round disk, an upright grating on a lower edge of the turntable unit, a flat grating joined to a lower end of the central shaft, a photoelectric interrupter for use with the upright grating to find out rotational speed and direction of the turntable unit, a photoelectric interrupter for use with the flat grating to find out rotational speed and direction of the round disk; the round disk can be manually rotated to send out scratch sound effects; the user is allowed to touch the touch-control plate so as to produce a touch signal, thus making the player send out, according to the touch signal, a particular one of various scratch sound effects.

### BACKGROUND OF THE INVENTION

1. Field of the Invention

The present invention relates to a digital audio signal player, more particularly one, which is more convenient to use, and has smaller size and more functions.

2. Brief Description of the Prior Art

In order to help increase hot and exciting atmosphere in a concert or a party such as is held in a PUB or a dancing hall, the DJ usually makes the music played with scratch sound effects by means of manually moving the analogue vinyl record positioned on the turntable at changing speeds and in alternate directions. As soon as the DJ stops moving the record with his hands, the record player will start playing the record in the normal way again. However, a single analogue vinyl record has very limited capacity to store music in, and a DJ has to prepare a lot of vinyl records in every event, and the records are likely to cause the DJ inconvenience due to the large size and heavy weight. Moreover, conventional vinyl records are prone to be damaged when they are manually moved relative to the turntable. CD/MP3 records have larger capacity, and are smaller in size and more convenient to use than conventional vinyl records.

Therefore, various types of audio signal players are developed for DJ to play CD/MP3 records and produce scratch sound effects.

Referring to FIG. 4, a currently available digital audio signal player 3 includes an actuating device 31, a turntable 32, a grating 33, and an optical sensor 34. The actuating device 31 has an output shaft 311. The turntable 32 is secured around an upper end of the output shaft 311 while the grating 33 is secured around a lower end of the output shaft 311; thus, the turntable 32 and the grating 33 will rotate at the same speed and in the same direction when the output shaft 311 rotates. The optical sensor 34 is used for detecting movement of the grating 33. When the user is manually rotating a round disk 321 positioned on the turntable 32 to produce various scratch sound effects, he would possibly change the speed of rotation of the turntable 32. Because of the optical sensor 34 and the grating 33, the speed and direction of rotation of the turntable 32 will be found out when the user is manually rotating the round disk 321.

Referring to FIG. 5, another currently available digital audio signal player 4 includes an actuating device 41, a turntable 42, a magnet seat 43, an induced magnet 431, and a magnetic sensing plate 432. The actuating device 41 has an output shaft 411. The turntable 42 is secured around an upper end of the output shaft 411, and the magnet seat 43 and the turntable 42 will rotate at the same speed and in the same direction when the output shaft 411 rotates. The induced magnet 431 is secured on a bottom side of the magnet seat 43. The magnetic sensing plate 432 is used for detecting movement of the induced magnet 431. When the user is manually rotating a round disk 421 positioned on the turntable 42 to produce various scratch sound effects, he would possibly change the speed of rotation of the turntable 42. Because of the magnetic sensing plate 432 and the induced magnet 431, the speed of rotation of the turntable 42 will be found out.

From the above description, it can be seen that when the above-mentioned digital audio signal players are used, the users are allowed to manually rotate the round disks on the turntables so as to produce certain scratch sound effects. However, such method of producing scratch sound effects has its limitation; the users can only produce some certain kinds of scratch sound effects, and he isn't allowed to use other methods to add other scratch sound effects to the current ones while manually rotating the round disks on the turntables. Furthermore, each of the digital audio signal players has to be equipped with a pick-up for reading signals of the round disk, causing increase to the size of the audio signal players. Consequently, the audio signal players are relatively big.

Referring to FIG. 6, yet another currently available digital audio signal player 5 includes a hollow housing part 51, a playing device 52, a turntable mechanism 53, an actuating mechanism 54, and a signal reading mechanism 55. The playing device 52 is used for playing a CD. The turntable mechanism 55 includes first and second turntables 531, 532 on an upper side of the hollow housing part 51, and a coupling plate 533 sandwiched between the first and the second turntables 531, 532. The actuating mechanism 54 includes a rotary shaft 541, and an electromagnetic rotating seat 542; the rotary shaft 541 projects from the upper side of the hollow housing part 51, and is connected to the turntable mechanism 53 such that the turntable mechanism 53 and the rotary shaft 541 can rotate at the same speed and in the same direction; the electromagnetic rotating seat 542 is used for making the turntable mechanism 53 rotate. The signal reading mechanism 55 includes first and second light blocking plates 551, 553, first and second photoelectric interrupters 552, and 554; the first light blocking plate 551 will rotate at the same speed and in the same direction as the first turntable 531 while the second light blocking plate 553 will rotate at the same speed and in the same direction as the rotary shaft 541; the first photoelectric interrupter 552 will read signals of the first light blocking plate 551 while the second photoelectric interrupter 554 will read signals of the second light blocking plate 553. Therefore, the playing device 52 will produce normal audio effects when the turntables 531, 532 rotate in the same direction and at the same speed. And, the playing device 52 will produce scratch sound effects when the first and the second turntables 531, 532 rotate in different directions or at different speeds.

The above audio signal player doesn't have to be further equipped with a pick-up because it has the first and the second photoelectric interrupters and light blocking plates for finding out the rotational speed and direction of the rotary shaft and the first turntable. However, the user still isn't allowed to produce scratch sound effects with another method except manually rotating the round disk on the turntable. Furthermore, the first and the second light blocking plates will cause increase to the thickness of the audio signal player. Consequently, the audio signal player occupies much space, and is inconvenient to use.

### SUMMARY OF THE INVENTION

It is a main object of the invention to provide an improvement on a digital audio signal player to overcome the above-mentioned problem. The digital audio signal player of the invention includes a turntable unit, a conductive touch-control plate on top of the turntable unit, a round disk, a conductive central shaft joined to the touch-control plate and the round disk, an upright grating on a lower edge of the turntable unit, a flat grating joined to a lower end of the central shaft, a photoelectric interrupter for use with the upright grating to find out rotational speed and direction of the turntable unit, a photoelectric interrupter for use with the flat grating to find out rotational speed and direction of the round disk. The round disk can be manually rotated to send out scratch sound effects, and the user is allowed to touch the touch-control plate so as to produce a touch signal, thus making the player send out, according to the touch signal, a particular one of various scratch sound effects. Because the upright grating is positioned on the lower side of the turntable unit, and the flat grating is secured on the lower end of the central shaft, the present player can be manufactured in a smaller size.

### BRIEF DESCRIPTION OF THE DRAWINGS

The present invention will be better understood by referring to the accompanying drawings, wherein:

FIG. 1 is an exploded perspective view of the digital audio signal player in the present invention,

FIG. 2 is a partial exploded sectional view of the present invention (1),

FIG. 3 is a partial sectional view of the present invention (1),

FIG. 4 is a partial exploded sectional view of the invention (2),

FIG. 5 is a partial lateral sectional view of the invention,

FIG. 6 is a partial exploded sectional view of the invention (3),

FIG. 7 is a partial sectional view of the present invention (2),

FIG. 8 is a partial exploded sectional view of the invention (4),

FIG. 9 is a partial exploded sectional view of the invention (5),

FIG. 10 is a perspective sectional view of the present invention,

FIG. 11 is a lateral sectional view of the present invention,

FIG. 12 is a view of the present digital audio signal player in use,

FIG. 13 is a lateral sectional view of the first currently available digital audio signal player,

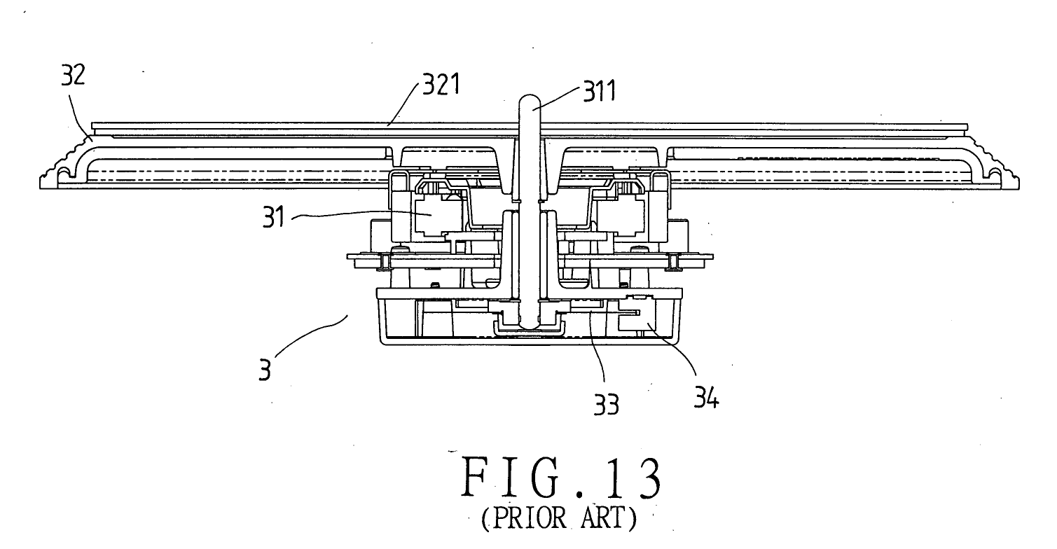

FIG. 14 is a lateral sectional view of the second currently available digital audio signal player, and

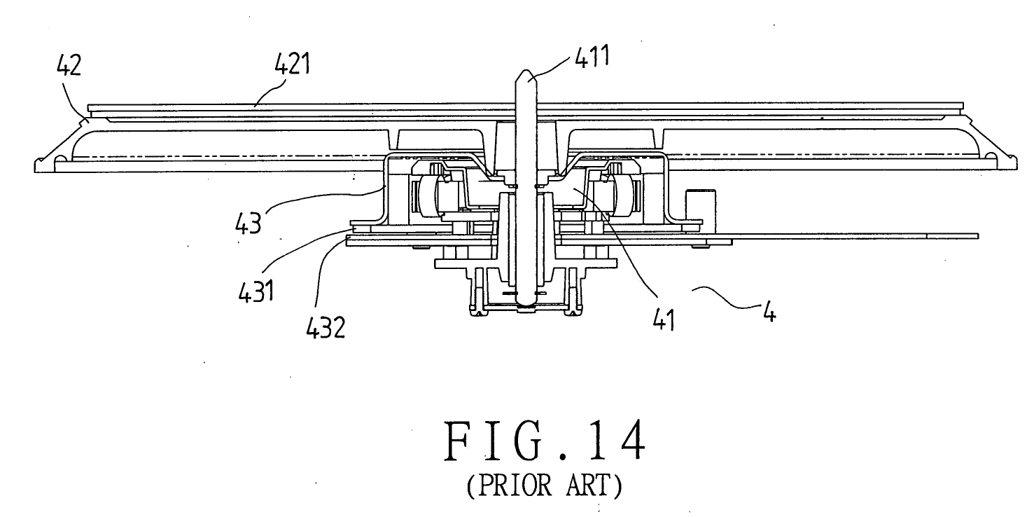

FIG. 15 is a lateral sectional view of the third currently available digital audio signal player.

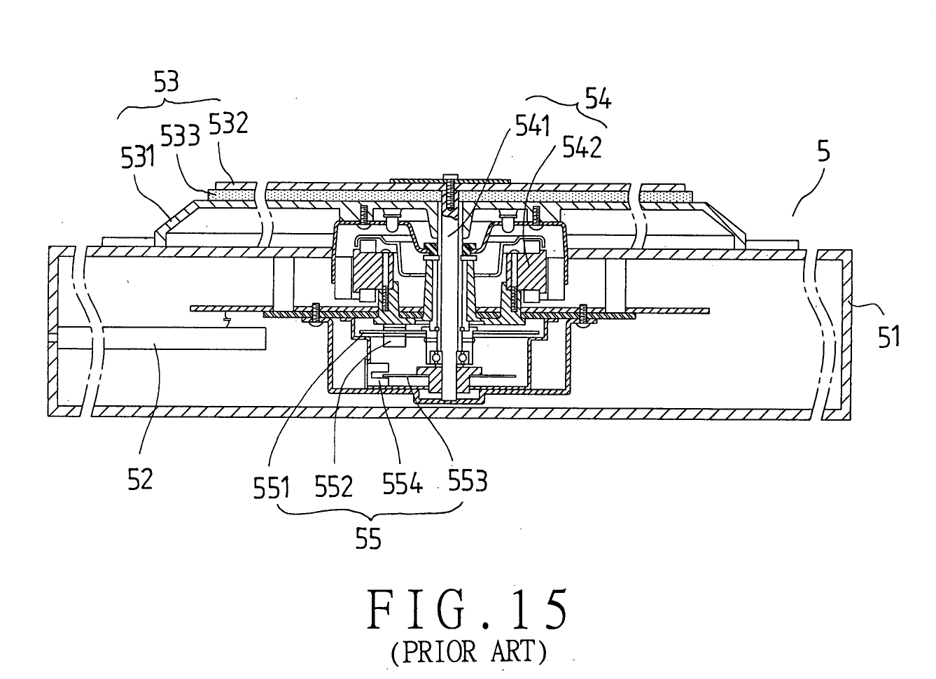

### DETAILED DESCRIPTION OF THE PREFERRED EMBODIMENTS

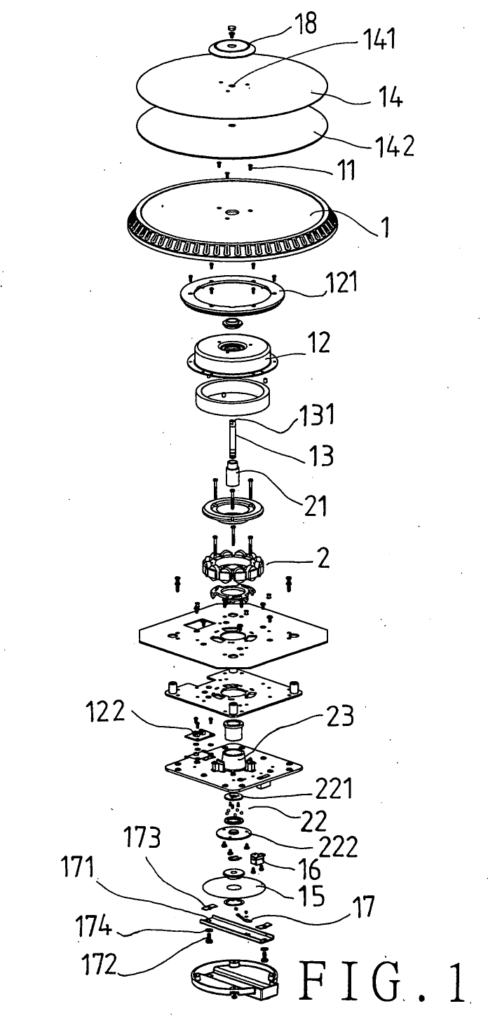

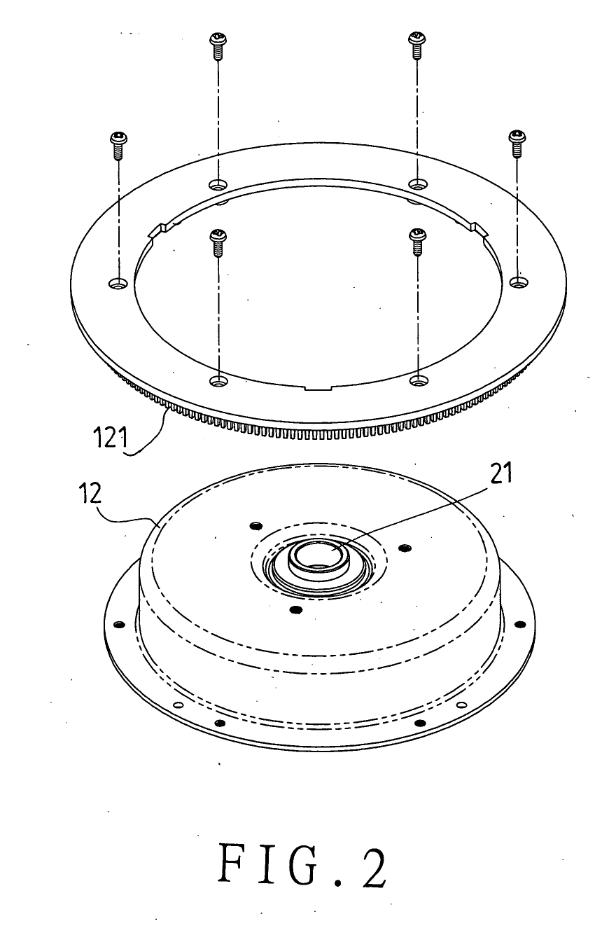

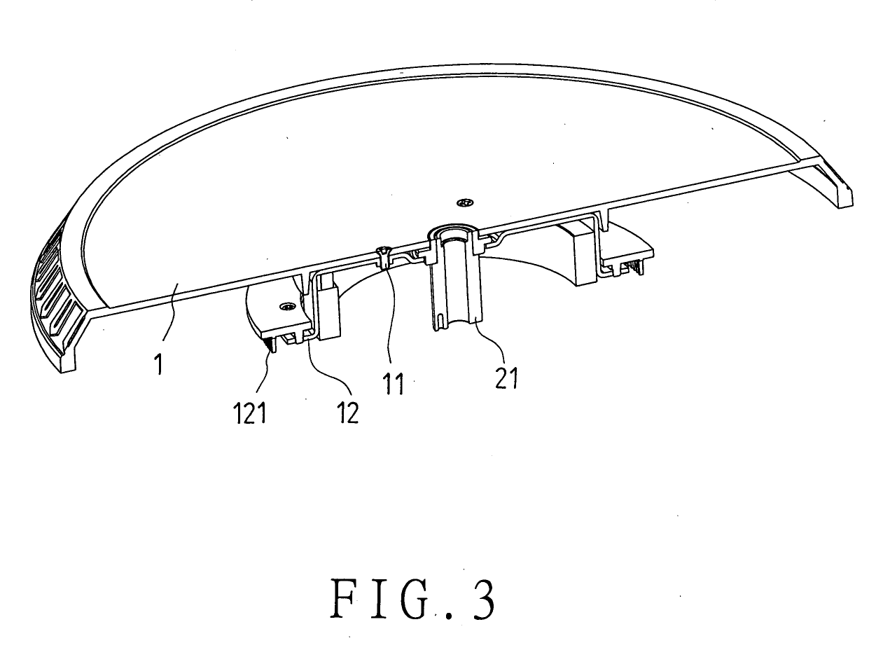

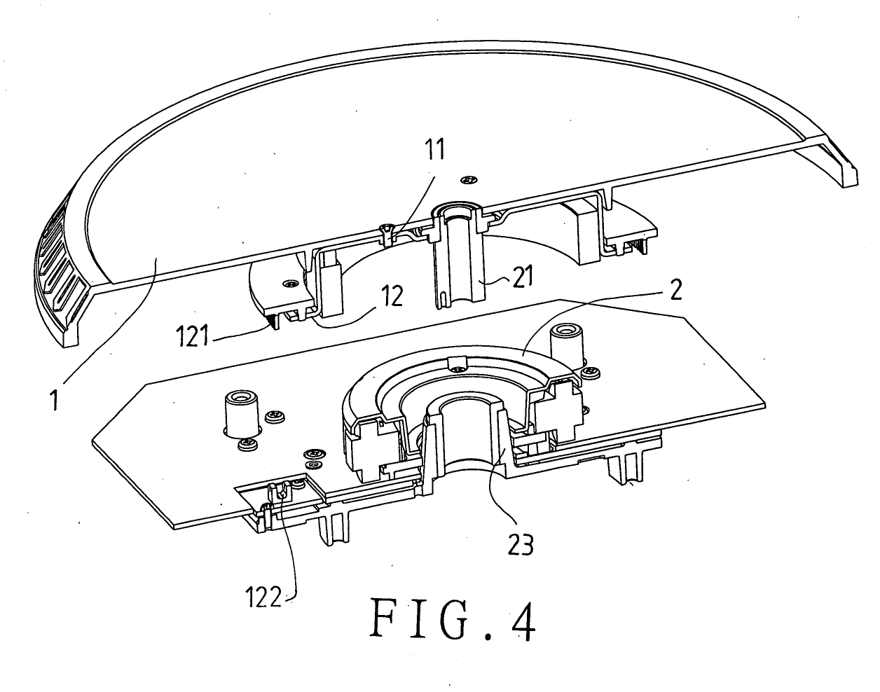

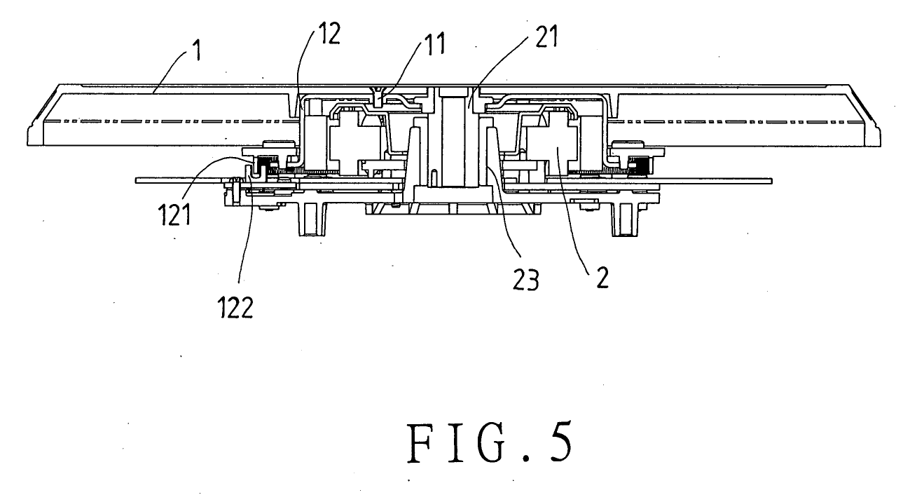

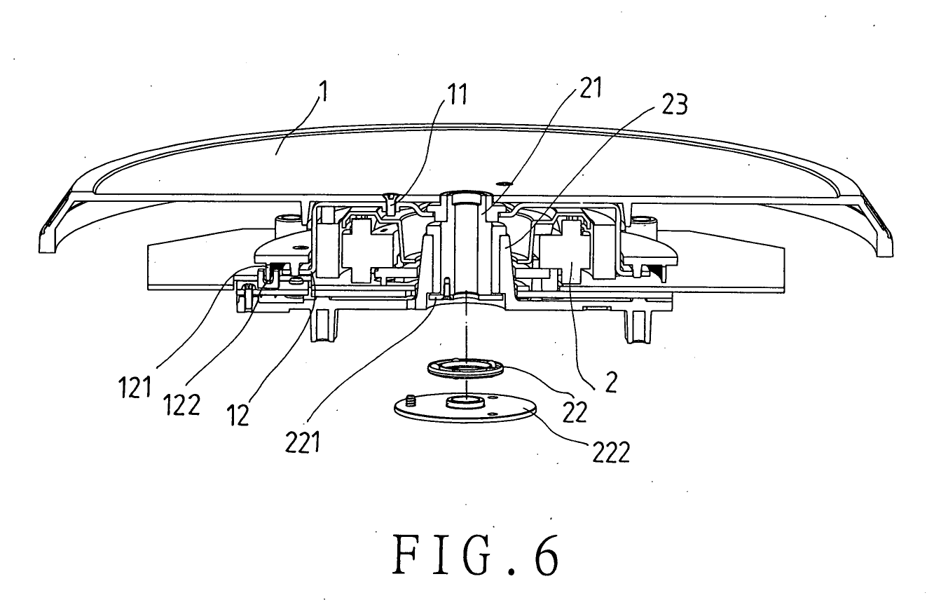

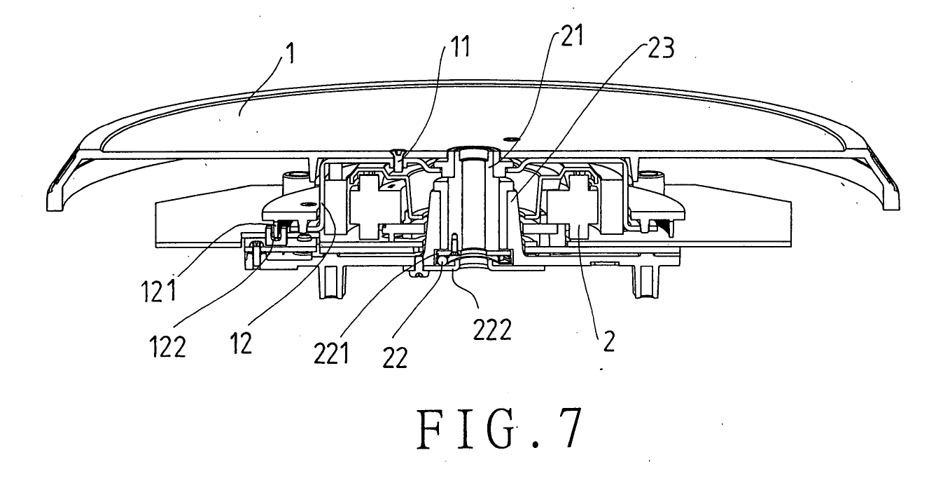

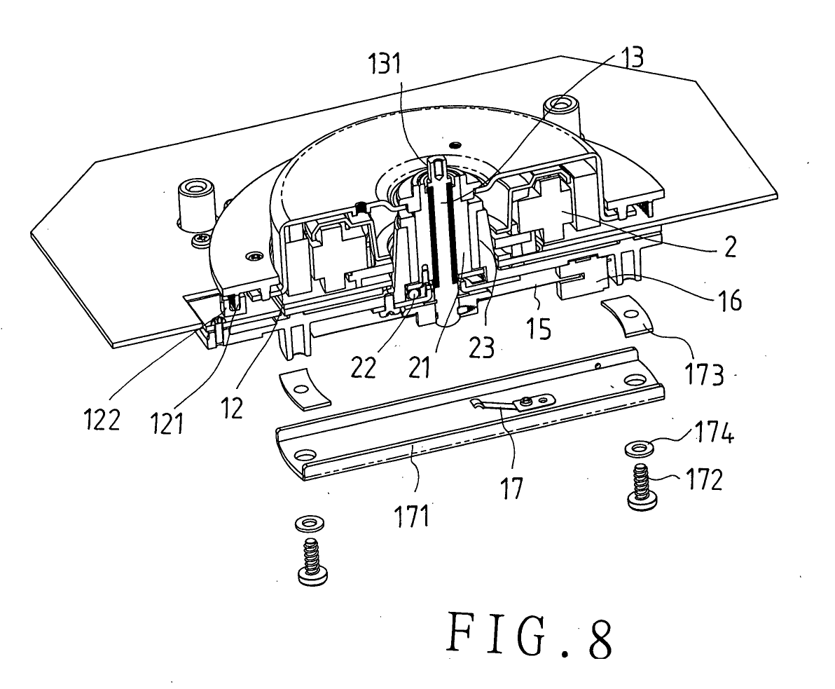

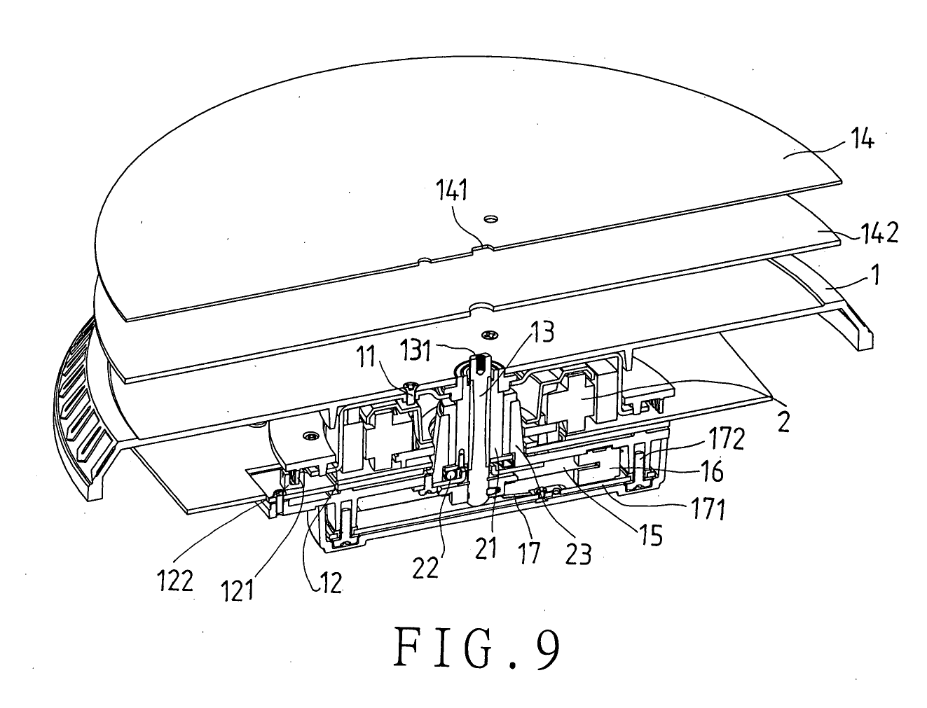

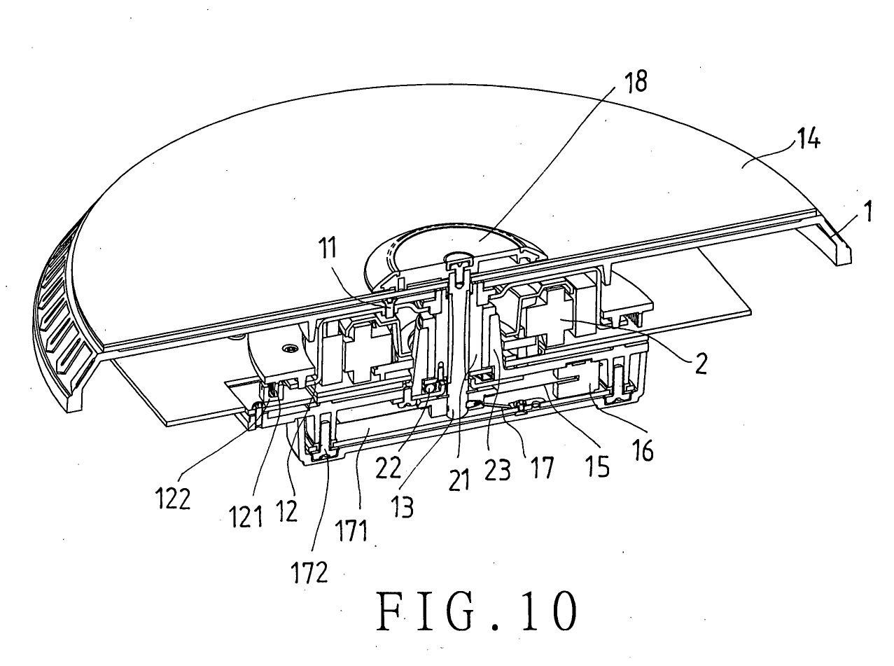

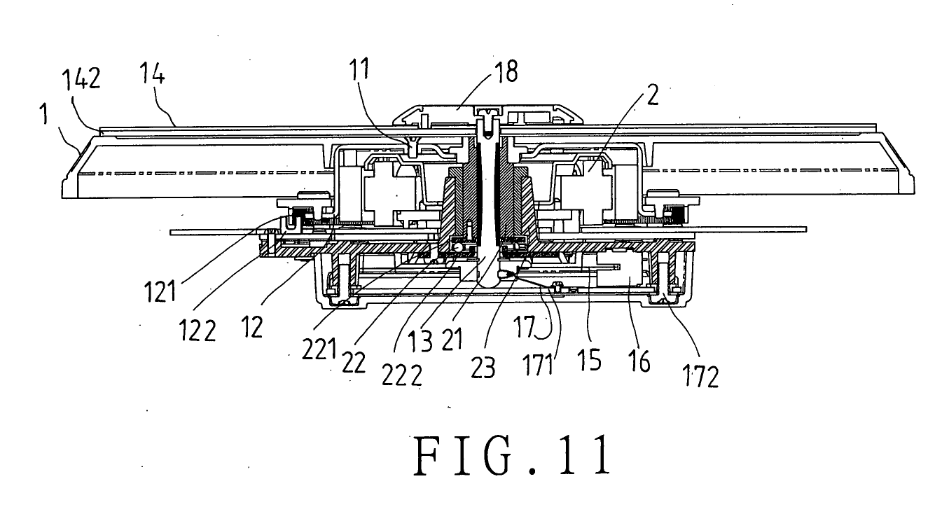

Referring to FIGS. 1 to 11, a preferred embodiment of a digital audio signal player includes:

a turntable unit 1;

an actuating unit 2 having an output shaft 21; an upper ringed pad 221 is securely joined to a lower end of the output shaft 21;

a magnet seat 12; the magnet seat 12 is secured on a bottom side of the turntable unit 1 by means of threaded fixing elements 11 such that the magnet seat 12 and the turntable unit 1 can't rotate relative to each other; the magnet seat 12 is securely joined to the output shaft 21 of the actuating unit 2 at a center thereof;

an upright grating 121 on a lower edge of the magnet seat 12;

a photoelectric interrupter 122 for use with the upright grating 121;

a motor seat formed with an axle hole 23;

a lower ringed pad 222 is secured in a lower end of the axle hole 23;

a ball bearing 22 positioned between the upper and the lower ringed pads 221 and 222; the ball bearing 22 is supported on the lower ringed pad 222 such that the output shaft 21 will rotate smoothly thereon;

a central shaft 13 inserted in the output shaft 21; the central shaft 13 has an inner part made of electricity-conductive materials, an insulating outer part wrapped around the electricity-conductive inner part, and a flat side 131 at an upper end;

a round pad 142 positioned on the turntable unit 1;

a round disk 14 positioned on the round pad 142; the round disk 14 has a central hole 141, which has a flat side; the central shaft 13 is fitted in the central hole 141 of the round disk 14 with the flat side 131 being next to the flat side of the central hole 141 such that the central shaft 13 and the round disk 14 will rotate at the same speed and in the same direction;

a flat grating 15 securely joined to a lower end of the central shaft 13;

a photoelectric interrupter 16 for use with the flat grating 15;

a motor base 171; threaded connecting elements 172 are passed through two ends of the motor base 171 to secure the motor base 171 in position; the motor base 171 is insulated by means of insulating ringed pads 173 and 174;

a conducting part 17; the conducting part 17 is positioned on the motor base 171 and joined to the lower end of the central shaft 13; and

a touch-control plate 18 made of electricity-conductive materials; the touch-control plate 18 is positioned over and joined to the upper end of the central shaft 13.

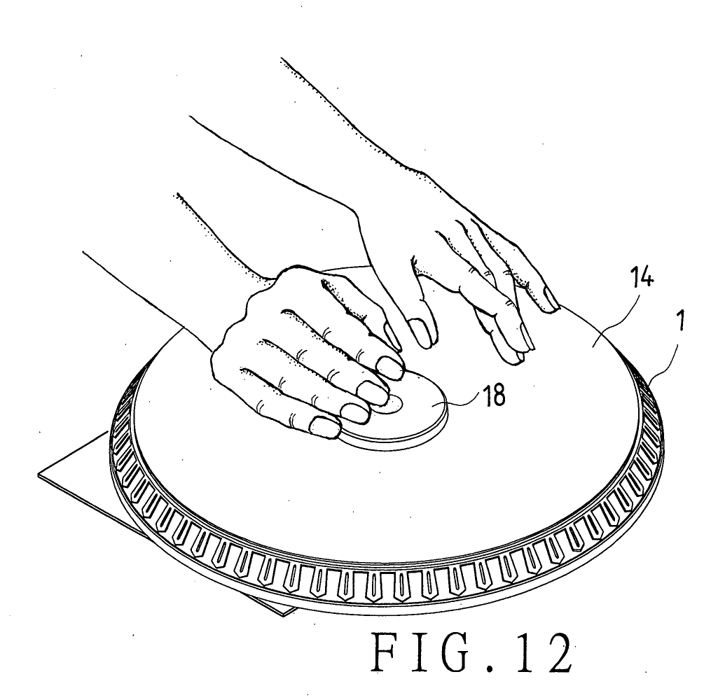

Therefore, if the user presses and rotates the round disk 14 manually while the output shaft 21 of the actuating unit 2 is making the turntable unit 1 rotate together with it, the speed and direction of rotation of the round disk 14 will be found out by means of the flat grating 15 and the photoelectric interrupter 16, and a certain scratch sound effect will be produced according to the speed and direction of rotation of the round disk 14. At the same time, the upright grating 121 and the photoelectric interrupter 122 will measure change of the speed of the turntable unit 1, and make the speed kept at a constant one accordingly. Referring to FIG. 12, or alternatively, the user can touch the touch-control plate 18 while manually rotating the round disk 14; thus, a touch signal is transferred into the digital audio signal player through the conductive touch-control plate 18 and the conductive inner part of the central shaft 13, and the player sends out a particular scratch sound effect according to the touch signal. Furthermore, because there is the ball bearing 22 positioned between the output shaft 21 of the actuating unit 2 and the lower end of the axle hole 23 of the motor seat, the output shaft 21 will start to make the turntable unit 1 rotate at the normal speed and in the normal direction again immediately after the user stops pressing the round disk 14, without any delay.

From the above description, it can be easily seen that the digital audio signal player of the present invention has the following advantages over the conventional ones:

1. The digital audio signal player has more functions; besides allowing the user to produce scratch sound effects through manually rotating the round disk, the player allows the user to produce additional scratch sound effects through touching the touch-control plate to produce touch signals, which will be transferred into an internal circuit of the player through the electricity-conductive inner part of the central shaft.

2. Because of the ball bearing positioned between the output shaft of the actuating unit and the lower end of the axle hole of the motor seat, the original speed and direction of rotation of the turntable unit will be recovered immediately after the user stops pressing the round disk. Therefore, there won't be any delay, and the present player will play music more smoothly.

3. Because the upright grating is positioned on the lower edge of the magnet seat secured on the bottom side of the turntable unit, and because the flat grating is secured on the lower end of the central shaft, the present player can be manufactured in a smaller height. Therefore, the present player has a smaller size than the conventional ones.

4. Because the magnet seat is secured on the bottom of the turntable unit by means of threaded fixing elements, it will certainly rotate in the same speed and in the same direction as the turntable unit. In other words, it isn't possible for the magnet seat to slide on the turntable unit.

5. Because the central shaft includes the conductive inner part, and the insulating outer part around the inner part, touch signals from the touch-control plate can be transferred through the central shaft. Furthermore, because the flat grating is securely joined to the lower end of the central shaft, rotation of the central shaft allows the speed and direction of rotation of the round disk to be found out by means of the flat grating and the photoelectric interrupter.

What is claimed is:

1. A digital audio signal player, comprising
a turntable unit;
an actuating unit having an output shaft; the output shaft having an upper ringed pad securely joined to a lower end thereof;
a magnet seat; the magnet seat being secured on a bottom side of the turntable unit by means of threaded fixing elements; the magnet seat being securely joined to the output shaft of the actuating unit at a center thereof;
an upright grating on a lower edge of the magnet seat;
a photoelectric interrupter for use with the upright grating in order to find out speed and direction of rotation of the turntable unit;
a motor seat formed with an axle hole;
a lower ringed pad secured in a lower end of the axle hole of the motor seat;
a ball bearing positioned between the upper and the lower ringed pads;
a central shaft inserted in the output shaft; the central shaft including an inner part made of electricity-conductive materials, and an insulating outer part wrapped around the electricity-conductive inner part; the central shaft having a flat side at an upper end thereof;
a round disk having a central hole, which has a flat side; the central shaft being fitted in the central hole of the round disk with the flat side thereof being next to the flat side of the central hole;
a flat grating securely joined to a lower end of the central shaft;
a photoelectric interrupter for use with the flat grating in order to find out speed and direction of rotation of the round disk; and
an electricity-conductive touch-control plate positioned over and joined to the upper end of the central shaft;
whereby a person is allowed to manually rotate the round disk to make the digital audio signal player send out scratch sound effects; and
whereby a person is allowed to touch the touch-control plate so as to produce a touch signal, thus making the digital audio signal player send out, according to the touch signal, a particular one of various scratch sound effects stored in the digital audio signal player.
